(19) United States
(12) Patent Application Publication
(10) Pub. No.: US 2012/0261275 A1
(43) Pub. Date: Oct. 18, 2012

(54) CHILD RESISTANT PACKAGE WITH FLOATING PANEL

(76) Inventor: Derek Intini, La Prairie (CA)

(21) Appl. No.: 13/261,284

(22) PCT Filed: Nov. 5, 2010
(86) PCT No.: PCT/CA2010/001781

§ 371 Date: Jun. 8, 2012

(30) Foreign Application Priority Data
Nov. 6, 2009 (CA) 2,684,816
Jan. 26, 2010 (CA) 2,691,022

(51) Int. Cl. B65D 55/02; A61J 1/03; B65D 75/36

(52) U.S. Cl. 206/1.5; 206/532

(57) ABSTRACT

A package comprising a blister pack (50) having a plurality of blister pockets (52) formed therein, a foil layer (54) overlying the blister pockets (52), an outer sleeve (10) comprising a top wall (12), a bottom wall (14) and a pair of side walls (16, 18), a floating panel (21) extending from one of the walls and being located interiorly of the outer sleeve (10) adjacent to the blister pack (50), the blister pack (50) being interior of the outer sleeve, a locking member (60) on the blister pack (50), the locking member (60) being engageable and disengageable with the floating panel (21) so as to deny or permit the blister pack to slide out of the outer sleeve (10) to permit access to the blister pockets (52).

### FIELD OF THE INVENTION

The present invention relates to packages for medication such as capsules, tablets and the like and more particularly relates to a child resistant and senior friendly package.

### BACKGROUND OF THE INVENTION

As is known in the art, it is desirable to provide packaging for medicaments which are child resistant in order to prevent young children from gaining access to the contents of the packaging. While there are a wide variety of child resistant packages in the marketplace, a problem which occurs with many such packages is the degree of difficulty in opening and which does not render the package senior friendly. In other words, if a too complicated mechanism is utilized to prevent the children from gaining access to the package contents, this can also present problems for seniors. Since seniors are the most frequent users of the medicaments and occasionally suffer from some disability in opening packages, one must strike a balance between being child resistant while also being senior friendly.

A very common type of package known in the art is referred to as a blister package. Such blister packages comprise of a blister layer formed of a suitable plastic material and which has capsule receiving pockets formed therein. The capsule receiving pockets are covered with a foil thereover the back of the package with the blister layer being secured to the blister package. For opening, the user will press on the blister pocket to force the capsule or other item in the blister pocket to break through the foil or peel the foil lidding off each pocket and thus be available for use.

Reference herein will be made to the term capsule as being placed in the blister pocket; it will be understood that any other item whether it be a tablet, pill or the like may be utilized.

### SUMMARY OF THE INVENTION

It is an object of the present invention to provide a child resistant senior friendly package which can be formed on conventional equipment to thus render the package therefore relatively simple and inexpensive.

According to one aspect of the present invention, there is provided a package comprising a blister pack having a plurality of blister pockets formed therein, a foil layer overlying the blister pockets, an outer sleeve comprising a top wall, a bottom wall and a pair of side walls, a floating panel extending from one of the walls and being located interiorly of the outer sleeve adjacent to the blister pack, the blister pack being interior of the outer sleeve, a locking member on the blister pack, the locking member being engageable and disengageable with the floating panel so as to deny or permit the blister pack to slide out of the outer sleeve to permit access to the blister pockets.

According to a further aspect of the present invention there is also provided a child resistant senior friendly package comprising a blister pack having a plurality of blister pockets formed therein, the blister having side walls, each of the side walls having an outwardly facing surface tapered inwardly from its bottom to its top, at least one projection extending upwardly from the blister pack, a sleeve extending about the blister pack, the sleeve having a top wall, at least one aperture formed in the top wall, the arrangement being such that the projection engages the aperture to prevent removal of the blister pack from the sleeve.

In a preferred embodiment of the present invention, one may employ a floating panel which is located interiorly of the sleeve and which floating panel assists in providing rigidity to the package while also permitting locking of the blister package within the sleeve to prevent access thereto until a predetermined step is taken to free the blister package. Once freed, the blister package may be moved exteriorly of the outer sleeve and access had to the contents of the blister package, which contents must be pushed through the lidding/foil or the lidding/foil must be peeled off each cavity to gain access to each content in each blister cavity. In one embodiment of the invention, the locking member may comprise a tab formed in the blister package and which tab will engage the floating panel. The engagement of the tab with the floating panel may be arranged through an aperture in the floating panel or by engagement with an end of the floating panel when the same is sized to provide such an arrangement. In an alternative embodiment, a tab on the end of the blister package may engage an aperture formed in the floating panel.

There is also provided a locking arrangement to prevent complete removal of the blister from the outer sleeve. This is desirable to prevent the user having to reinsert the blister package into the sleeve. In one embodiment, this arrangement may be provided by upwardly extending members of the blister package engaging an abutment on the outer sleeve. In an alternative arrangement, tapered, vacuum formed, one way locking side locks on the sides of the blister package may engage a diecut hole formed on the sides of the outer sleeve. In an alternative arrangement, the flange arrangement on the sides of the blister package may engage slits formed in the outer sleeve.

### BRIEF DESCRIPTION OF THE DRAWINGS

Having thus generally described the invention, reference will be made to the accompanying drawings illustrating embodiments thereof, in which:

FIG. 1 is a plan view of a blank used to form the outer sleeve of the package;

FIG. 2 is a top plan view of a blister pack used in the package of the present invention;

FIG. 3 is a side elevational view of the blister pack;

FIG. 4 is a plan view of the assembled package of the present invention;

FIG. 5 is a cross-sectional taken along the lines 5-5 of FIG. 4;

FIG. 6 is an enlarged sectional view illustrating the locking of the blister pack in the package;

FIG. 7 is a view similar to FIG. 6 illustrating the unlocking or opening of the package;

FIG. 8 is a partial sectional view illustrating movement of the blister pack out of the sleeve to permit access to contents of the blister pack;

FIG. 9 is a plan view of the bottom of the blister pack;

FIG. 10 is a plan view of a cardboard blank in a further embodiment of the present invention;

FIG. 11 is an exploded view illustrating the sleeve and blister pack in the embodiment of FIG. 10;

FIG. 12 is a perspective view illustrating partial removal of the blister pack from the sleeve;

FIG. 13 is a top plan view of the blister pack;

FIG. 14 is a longitudinal cross-sectional view thereof;

FIG. 15 is a partial sectional view illustrating movement of the blister pack within the sleeve;

FIGS. 16 and 16A are exploded views of further embodiments of a blister pack and sleeve;

FIG. 17 is a perspective view illustrating assembly of the sleeve and blister pack of FIG. 16;

FIG. 18 is a perspective view of a further embodiment;

FIG. 19 is a perspective view of a still further embodiment;

FIG. 20 is a perspective view of the embodiment of FIG. 19;

FIGS. 21 and 22 are views of further embodiments of a blister pack;

FIG. 23 is a side view thereof;

FIG. 24 is a plan view of a further embodiment of a blister pack according to the present invention;

FIG. 25 is a side view thereof;

FIG. 26 is a top plan view of the blank utilized for the sleeve; and

FIG. 27 is a perspective view of a modified package.

### DETAILED DESCRIPTION OF THE INVENTION

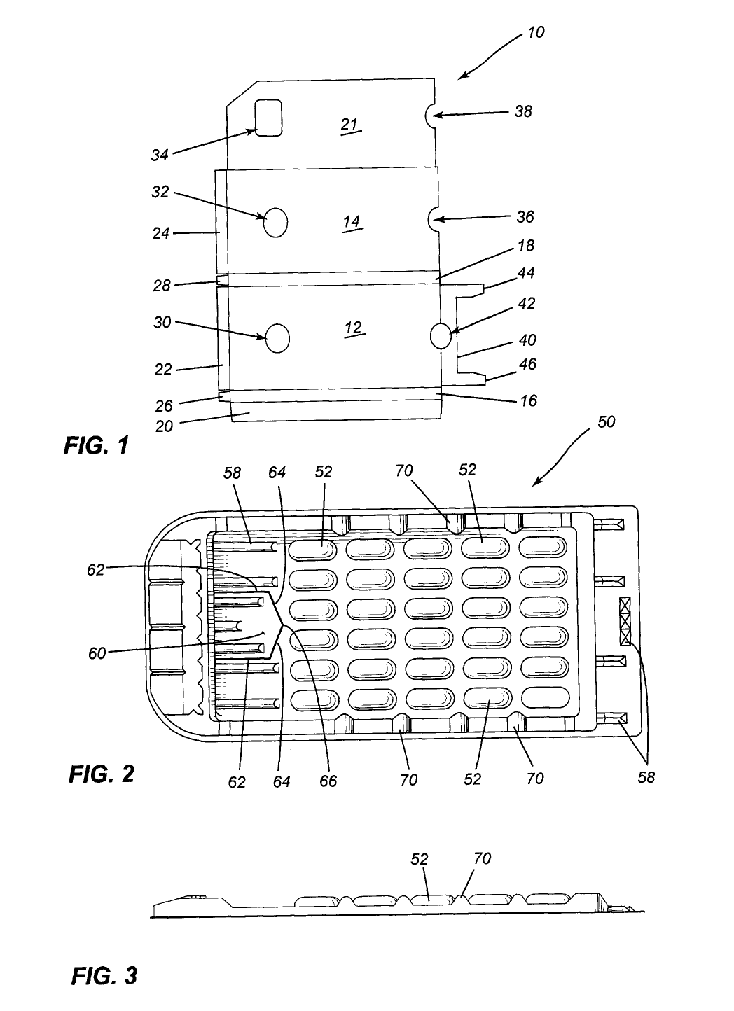

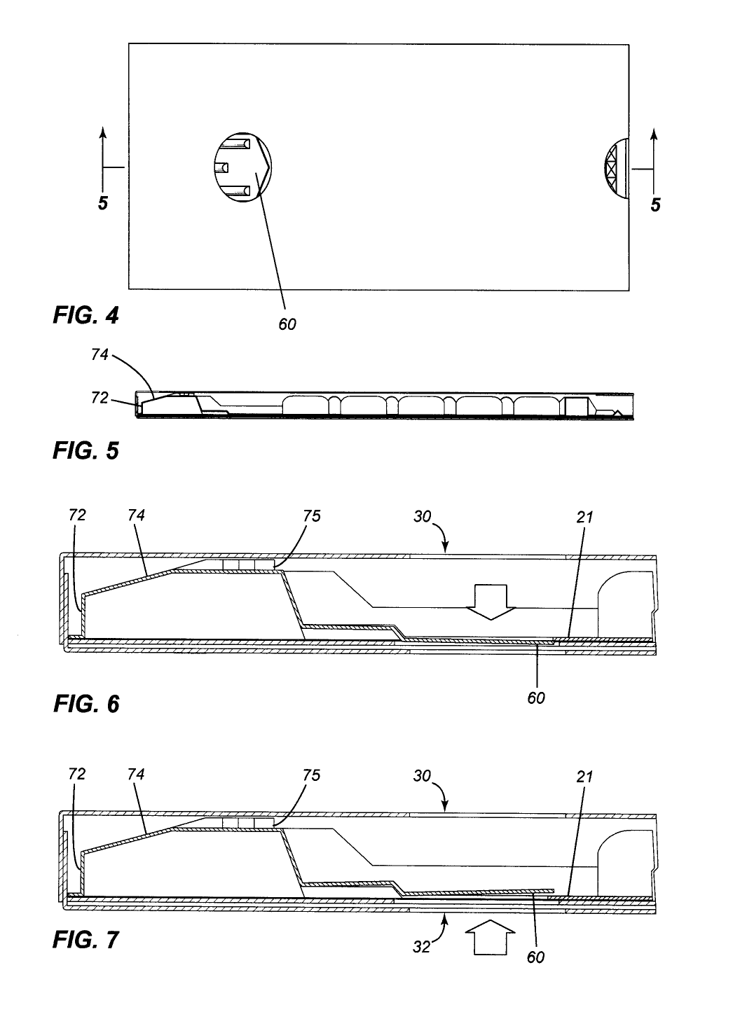

Referring to the drawings in greater detail and by reference characters thereto, there is illustrated in FIG. 1 a blank generally designated by reference numeral 10 and which is utilized to form the sleeve of the package of the present invention.

Blank 10 includes a top panel 12, a bottom panel 14, a side panel 16, a second side panel 18, and a securing panel 20. The above panels are conventional in forming a sleeve and are separated by appropriate fold lines. The terms top, bottom, and side are relative and refer to the usual orientation of the package.

As may be seen in FIG. 1, there is also provided a floater panel generally designated by reference numeral 21 and which is attached to a side marginal edge of bottom panel 14. As is also conventional, top panel 12 has a rear end closure 22; the bottom panel 14 has a rear end closure 24; and side panels 16, 18 have rear end closures 26, 28 respectively.

Formed interiorly of front panel 12, is an aperture 30 while bottom panel 14 also includes an aperture 32 which, when in the folded condition, are aligned with each other. An aperture 34 is also provided in floater panel 21 for reasons which will become apparent hereinbelow.

A semi-circular cut-out 36 is formed at the front end of bottom panel 14 and a similar semi-circular cut-out 38 is provided at the front end of floater panel 21.

A front end flap 40 is formed at the front edge of top panel 12 and there is an aperture 42 formed at the point of joinder of flap 40 and top panel 12. A pair of flanges 44 and 46 are associated with front end flap 40.

The package of the present invention includes a blister pack generally designated by reference numeral 50. Blister pack 50 includes a plurality of blisters 52 into which a medicament may be placed. The blisters 52 are sealed with a conventional foil layer 54 and preferably also with a pre-laminated paper/foil lidding 56.

The blister pack includes a plurality of ribs 58 located at various portions of the package and which may be provided in order to have appropriate reinforcement.

Blister pack 50 includes a locking member 60 formed at one end thereof and which is defined by a pair of die-cut side walls 62 and die-cut diagonal walls 64. The arrangement provides a leading tip 66.

The blisters 52 are preferably arranged in both longitudinal and traverse rows as shown in FIG. 53. At the side, there are provided raised portions 70 which are located between the traverse rows. Raised portions 70 assist in the movement of the package in and out of the sleeve.

It will also be noted that the blister pack 50 has a rounded configuration at its rear end to allow for easier insertion within the sleeve. To also aid in the insertion, there is provided a relatively short front wall 72 and an upwardly extending wall 74. Blister pack 50 also has projections 75 on the top thereof.

Blank 10 is assembled in a conventional manner with securing panel 20 being secured to bottom panel 14 with floater panel 21 being interior of the sleeve. Flap 40 is folded so as to also be located interiorly of the sleeve.

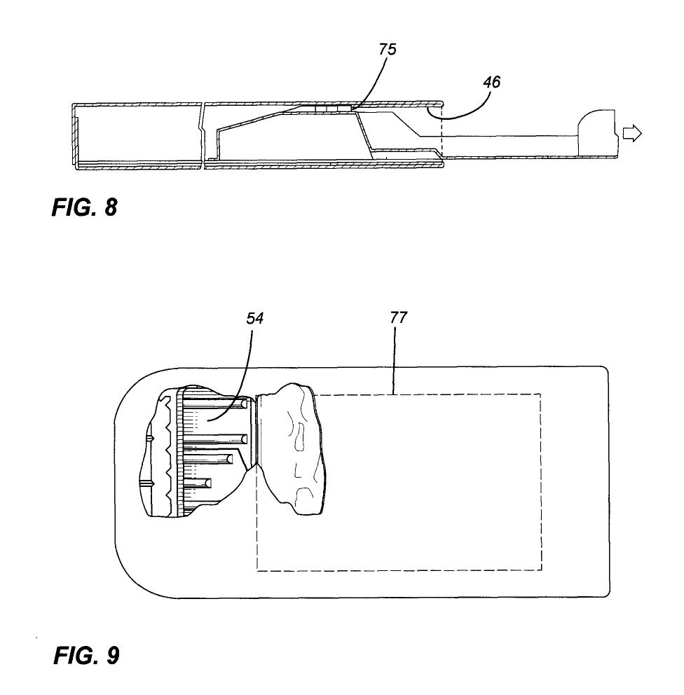

As shown in FIGS. 6 and 7, tab 60 may be moved either to a locking position (FIG. 6) where it engages against floater panel 21 through aperture 34 or an open position where the blister pack may be moved outwardly of the sleeve. However, motion of the blister pack outwardly of the sleeve is limited by the engagement of projections 75 with flanges 44, 46 as shown in FIG. 8.

In a preferred embodiment of the invention, a score line 77 is provided exteriorly of the blister pockets 52 in the foil or in paper/foil lidding 56. This prevents a child, who may have gained access to the packaging and broken through the foil or paper/foil, from accessing the blister pockets 52. In other words, the tearing or peeling of the paper of the foil or paper/foil would stop at the score line 77.

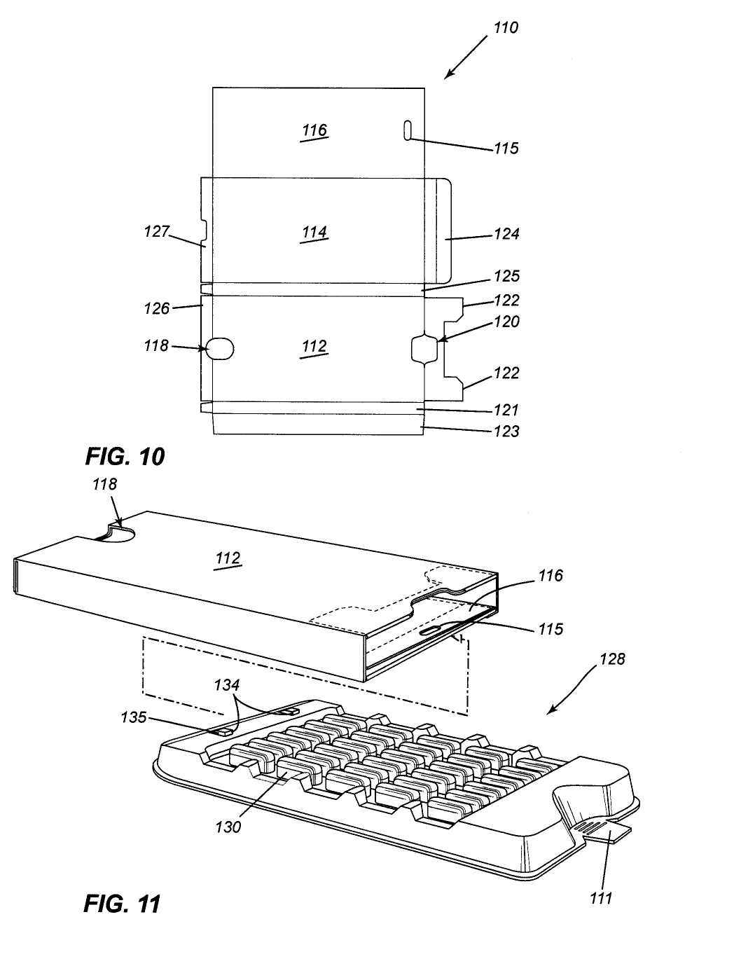

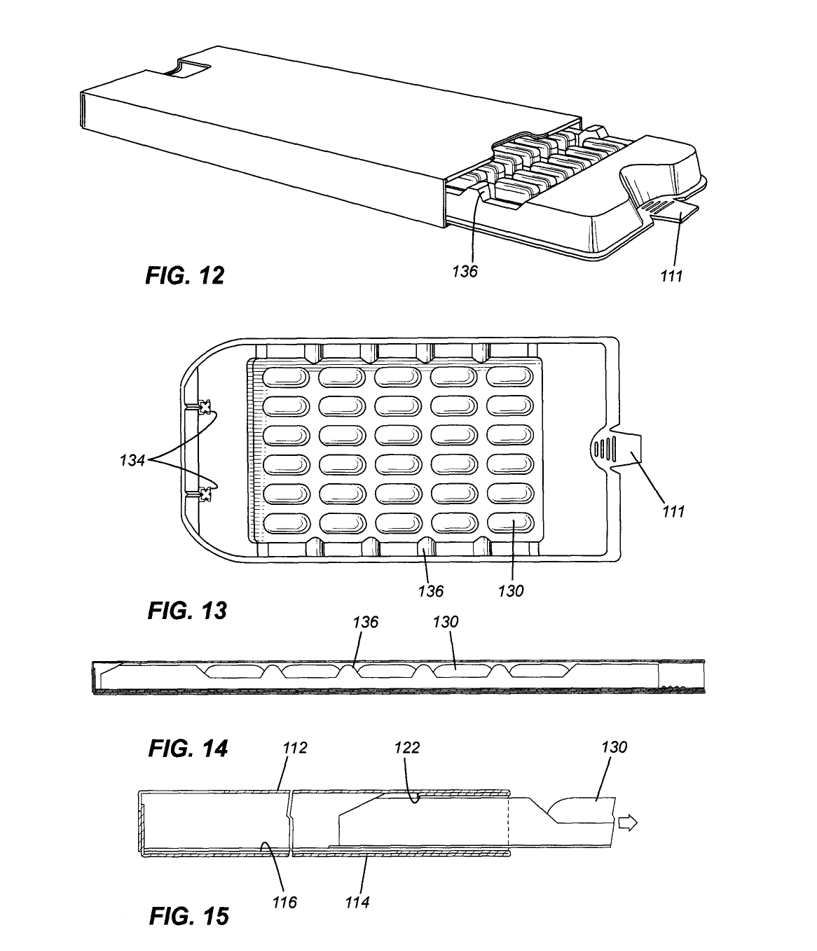

Referring to the embodiments of FIGS. 10 to 15 thereto, there is illustrated a blank for forming a sleeve and which blank is generally designated by reference numeral 110.

Blank 110 has a top panel 112, a bottom panel 114, and a floater panel 116. The panels are separated by fold lines as is well known in the art.

Top panel 112 includes a rear aperture 118 and a front aperture 120 for reasons which will become apparent hereinbelow. Floater panel 116 includes a locking aperture 115. A locking panel 122 is formed at the front end thereof while an end panel 124 is located at the front of bottom panel 114. End panels 126 and 127 are located at the rear of top panel 112 and bottom panel 114. A side wall panel 121 and a securing panel 123 are also formed while a second side wall panel 125 lies between panels 112, 114.

The package will include a blister pack generally designated by reference numeral 128 and which has a plurality of blister pockets 130 each having a capsule therein. At the front of blister pack 128, there is provided a tab 111 while at the rear there is provided an upwardly extending pair of locking towers or members 134. Locking members 134 have a tapered slope as designated by reference numeral 135 to permit ease of insertion of the blister pack into its sleeve. A plurality of projections 136 are formed on the side of blister pack 128 as in the first embodiment.

In use, the sleeve is assembled with floater panel 116 lying adjacent to bottom panel 114. Top panels 112 and 114 are secured together and the rear is closed using end panels 126 and 127 and two end flaps. Locking panel 122 is extended inwardly of the sleeve and end panels 124 may be utilized to close the sleeve.

Before closing, blister pack 128 is inserted and due to the sloping surface 135, little resistance is encountered. Tab 111 engages with aperture 115. The sizing of the tab is critical with the tab preferably having a length such that it extends beyond aperture 115 by a distance of between 0.3 and 2 mm, more preferably between 0.75 and 1.5 mm and in the most preferred embodiment, extends approximately 1 mm beyond the aperture 23 when in the locked position.

The floater panel 116 is also important because it allows the pack to withstand significant stresses while maintaining its locked position. Without the floater panel, the blister's lock would disengage with the slightest squeeze thus disengaging the tab from an aperture and rendering the blister free to slide out.

To unlock the blister, the user need only press gently on the leading edge of the floater panel and the lock is disengaged so that the blister is free to slide until locking members 134 engage locking flap 122. The user may then access the products within the blister pack in a conventional manner. To lock the pack, the blister is slid back in the sleeve and the blister's tab is pressed until the lock engages.

The rear aperture 118 serves different purposes. It is used to access the blister pack to push the blister so that the front tab is easily accessible. It is also a distraction to children since they see a hole and often assume it is the point of entry.

Preferably, the joinder of bottom panel 114 with end panel 124 is such that the tab will tear off if a child attempts to gain access and thus will not aid in unlocking the blister.

The sleeve may be made of any non-tear material such as paperboard laminated to polyfoil, PVC, PET, or any other suitable material.

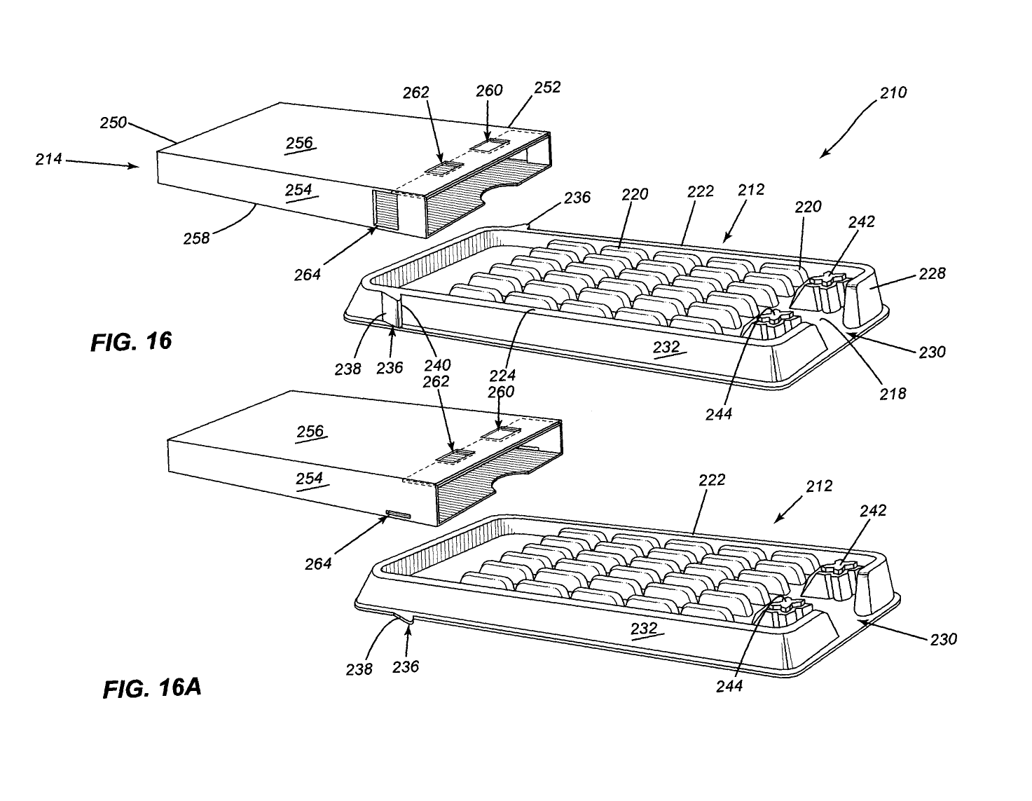

Referring to FIGS. 16 to 27 in greater detail there is illustrated a package generally designated by reference numeral 210 and which package 210 includes an insert 212, which is formed as part of 210 and a sleeve 214.

Insert 212, in the illustrated embodiment, is a blister pack 218 having a plurality of blister pockets 220 formed therein. A foil or paper/foil (not shown) seals the other side of blister pockets 20 as is well known in the art.

Blister 218 is formed to have side walls 222, 224 and end walls 226, 228. As will be seen in the drawings, an opening 230 is formed in end wall 228.

Side walls 222, 224 have inwardly and outwardly facing surfaces. Outwardly facing surface 232 of side wall 224 is tapered slightly inwardly from its bottom to its top. A similar arrangement is provided with respect to side wall 222.

Mounted on side walls 222, 224 are respective projections 234, 236. As projections 234, 236 are substantially identical, only one will be described herein. As may be seen in the drawings, projection 236 includes a sloping wall 238 and an abutting wall 240 for reasons which will be described hereinbelow. Located on the top surface of blister layer 218 are a pair of locking towers 242, 244 which are substantially identical. As may be seen, locking tower 244 has a sloped wall 246 for reasons which will be discussed hereinbelow. A similar arrangement is provided for locking tower 242.

Sleeve 214 has an end wall 250 and a pair of side walls 252, 254. Sleeve 214 also includes a top wall 256 and a bottom wall 258. In the top wall 256, there are provided a pair of top wall apertures 260, 262 while side wall 254 includes a side wall aperture 264. A similar aperture (not shown) is provided in side wall 252.

It will also be noted that in bottom wall 258, there is provided a recess 266.

In use, sleeve 214 is assembled with end wall 250 being secured in any known manner such that access may not be gained to the interior of the sleeve from this end. After being assembled, insert 212 is pushed into the open end of sleeve 214. This continues until locking towers 242, 244 engage top wall apertures 260, 262 to lock insert 212 in a fixed position with respect to sleeve 214. Locking towers 242, 244 can be as high as wall 222 and 224 or as flat as the flange on insert 212.

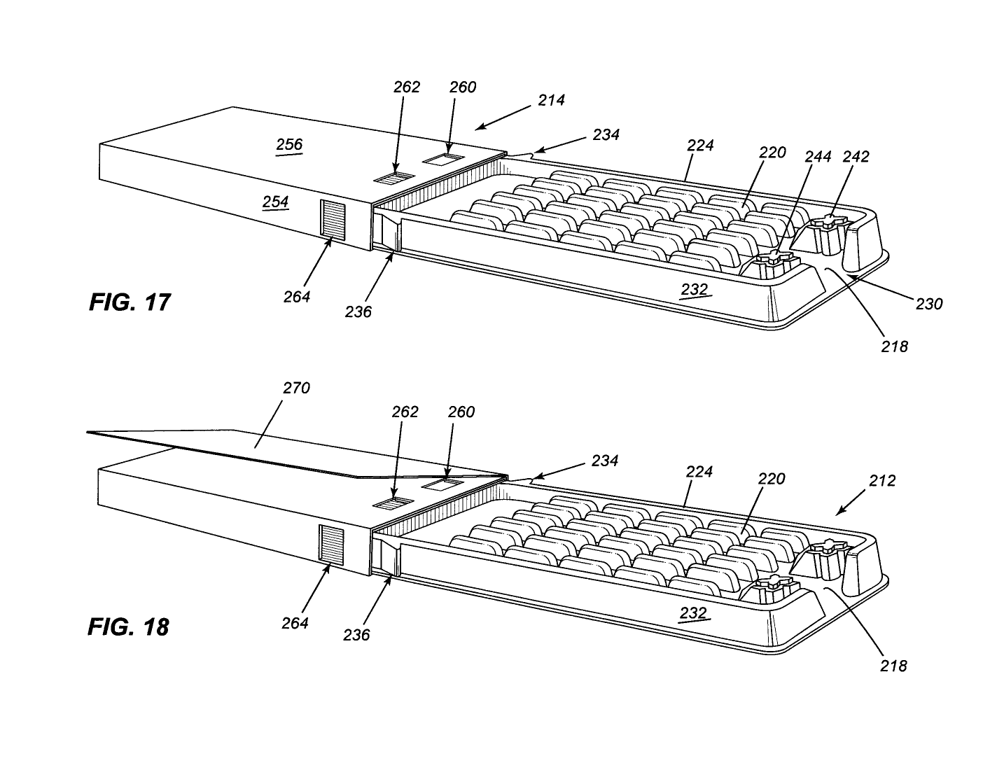

In order to gain access to insert 212, the sides of the sleeve 256 on the front of sides 254, 255 must be squeezed to free the tower locks 242, 244 to permit a slight bowing of top wall 256 and disengage from the diecut holes 260, 262 with the glued folded inner panel, which is an extension of top panel 256. When squeezing the front side walls of 254,255, while the insert locks are disengaged, insert 218 can be pulled out. When the insert 218 is pulled out, locks 236, 237 on insert 218 will lock into diecut holes 264, 265 and prevent the insert from being released from the sleeve 214 as shown in FIG. 17.

Insert 212 may then be pulled outwardly to gain access to the blister pockets 220 and the medicaments therein. Complete removal of the insert is prevented by engagement of projections 234, 236 with a respective side wall aperture 264 as shown in FIG. 1. In the variation in FIG. 16A, a locking element 275 is formed to engage a slit 277 by cutting flange 279.

In the embodiment of FIG. 18, there is provided an additional cover panel 270 which makes the package somewhat more child resistant as the child cannot see the lock mechanism. It also provides an extra panel for prescription information and the like.

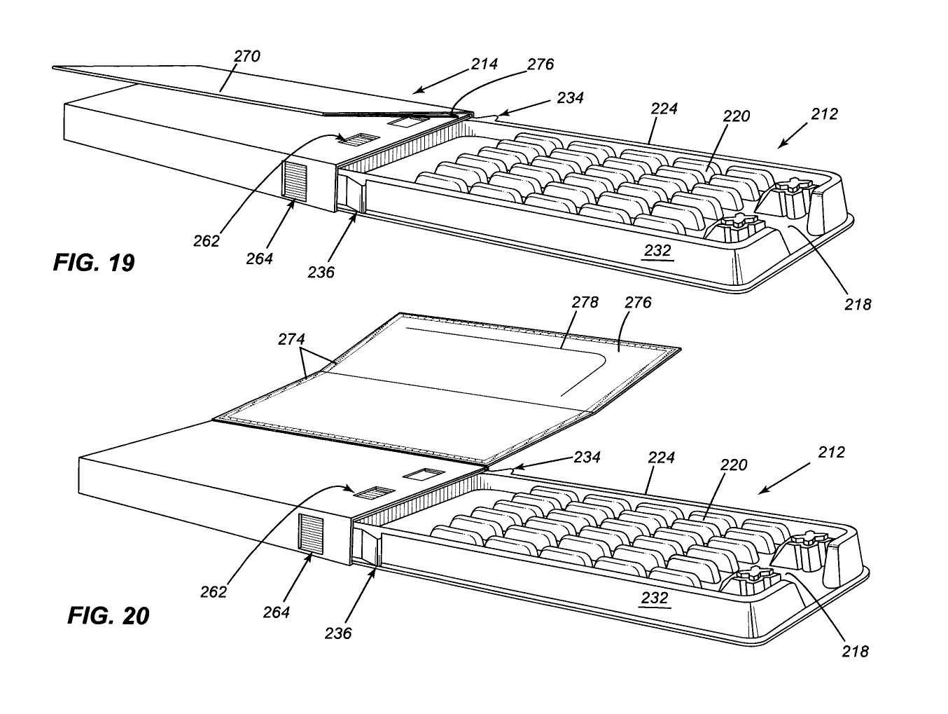

In the embodiment of FIGS. 19 and 20, a first panel 274 and a second panel 276 are provided for overlying top wall 256. First panel 274 and second panel 276 may be secured together by adhesive 274 or the like. Second panel 276 may also have a diecut 278 to permit the insertion of information therein.

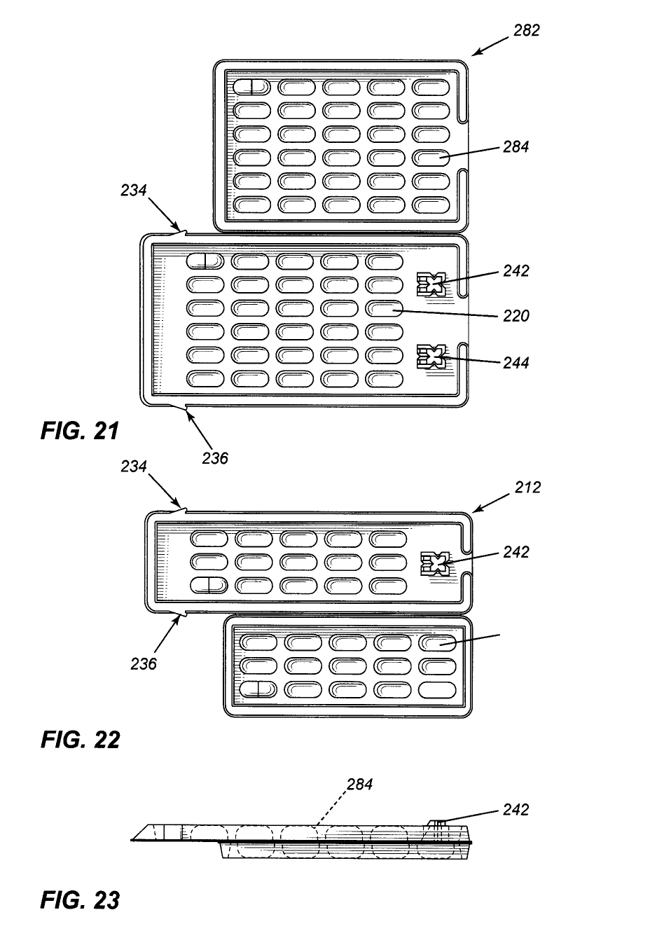

In the embodiment of FIGS. 21 and 22, there is provided an extra blister layer 282 also having pockets 284 formed therein. As will be noted, blister layer 282 is shorter in length to permit full access thereto.

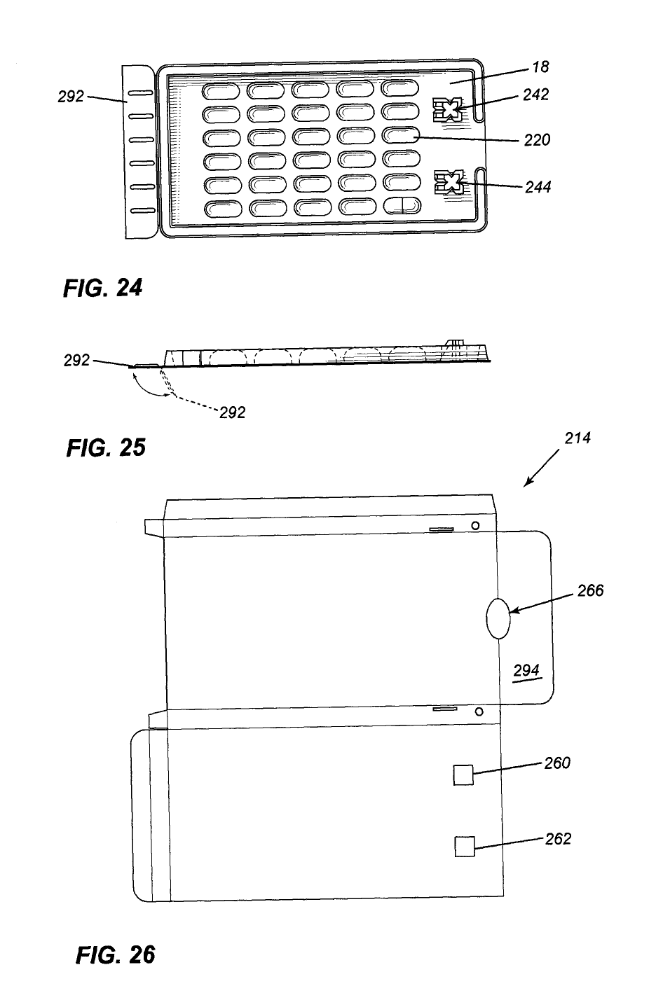

FIG. 24 illustrates an embodiment wherein locking projections 234, 236 are not utilized. Rather, there is provided a bendable flap 292 on blister layer 218. Sleeve 214 is provided with a foldable end wall 294 which is foldable inwardly and will engage flap 292 to prevent insert 212 from being pulled out of sleeve 214.

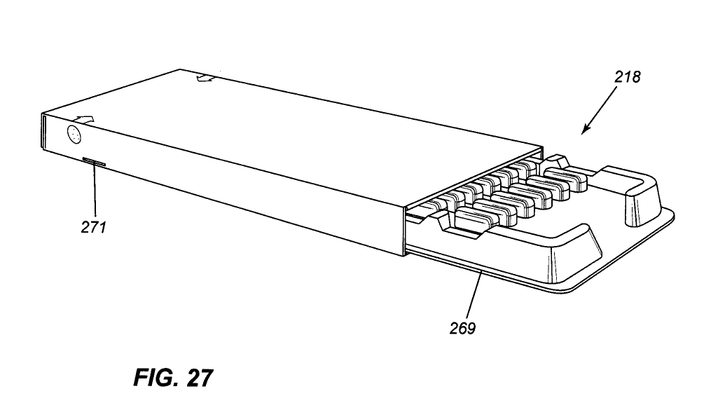

FIG. 27 illustrates an arrangement wherein locking projections are formed by die cutting a flange 269 and blister 218 which will engage slits 271.

The packages described above can be produced on standard form-fill-seal machinery. Ideally, they will be formed on a two-piece mold that can be adapted to suit many different product sizes. Thus, one would have a first mold for the outer wall portion of the blister and a second mold for the blister pocket area. Thus, one could size the blister pockets to be of different sizes and different quantities as desired.

It will be understood that changes and modifications may be made to the varying embodiments illustrated. One could, for example, change the arrangement of the various locking members. One could, for example, move the initial locking towers to the closed end of the sleeve which would require squeezing of the sides at the closed end. This would make the opening of the package for children somewhat more difficult. Furthermore, it will be understood that the packages may all be made to have a tapered wall on the blister for easy insertion. Thus, one skilled in the art could combine the various features of the embodiments shown herein as desired.

I claim:

1. A package comprising:
a blister pack (50) having a plurality of blister pockets (52) formed therein, a foil layer (54) overlying said blister pockets (52);
an outer sleeve (10) comprising a top wall (12), a bottom wall (14) and a pair of side walls (16, 18), a floating panel (21) extending from one of said walls and being located interiorly of said outer sleeve (10) adjacent to said blister pack (50), said blister pack (50) being interior of said outer sleeve;
a locking member (60) on said blister pack (50), said locking member (60) being engageable and disengageable with said floating panel (21) so as to deny or permit said blister pack to slide out of said outer sleeve (10) to permit access to said blister pockets (52).

2. The package of claim 1 wherein said locking member (60) comprises a tab formed in said blister pack (50).

3. The package of claim 2 further including a paper lidding (56) material secured to said foil layer (54).

4. The package of claim 3 further including a score line (77) in said paper lidding material, said score line (77) being exterior of said blister pockets (52) to inhibit peeling of said paper layer.

5. The package of claim 4 wherein each of said blister pockets (52) contains a medicament capsule.

6. The package of claim 1 further including a second locking member (75) engageable with a portion (46) of said outer sleeve to prevent removal of said blister pack from said outer sleeve when said blister pack is moved to a position so as to be partially exterior of said outer sleeve.

7. The package of claim 1 wherein said blister pockets (52) form both transverse and longitudinal rows.

8. The package of claim 7 further including raised portions (70) on sides of said blister pack, said raised portions (70) being intermediate said rows.

9. The package of claim 2 further including a tapered end (72, 74) to permit easy insertion of said blister pack in said outer sleeve.

10. The package of claim 2 wherein said floating panel has an aperture (34) therein, said aperture having a marginal wall which engages with said tab (60) to prevent movement of said blister pack (50).

11. The package of claim 1 wherein said locking member comprises a tab extending outwardly from said blister pack (158), said tab engaging an aperture (115) formed in said floating panel (116).

12. The package of claim 11 wherein said tab extends beyond aperture (115) by a distance of between 0.3 and 2.0 mm.

13. A child resistant senior friendly package (210) comprising:
a blister pack (218) having a plurality of blister pockets (220) formed therein, said blister (218) having side walls (222, 224), each of said side walls having an outwardly facing surface (232) tapered inwardly from its bottom to its top, at least one projection (234) extending upwardly from said blister pack (218);
a sleeve (214) extending about said blister pack (218), said sleeve having a top wall (256), at least one aperture (260) formed in said top wall (256), the arrangement being such that said projection (234) engages said aperture (260) to prevent removal of said blister pack (218) from said sleeve (214).
